(19) United States
(12) Patent Application Publication
(10) Pub. No.: US 2023/0134553 A1
(43) Pub. Date: May 4, 2023

(54) GRAPHENE BASED ADSORBENT MATERIAL FOR A SCRUBBER CONNECTED BY A VENT PORT TO AN EVAP CANISTER AND FORMING A PORTION OF A VEHICLE EVAP EMISSIONS MANAGEMENT SYSTEM FOR PREVENTING BLEED EMISSIONS AND PROVIDING LOW FLOW RESTRICTIONS

(71) Applicant: Martinrea International US Inc., Auburn Hills, MI (US)

(72) Inventors: Murali Chandrasekhar, Rochester, MI (US); Anindya Banerji, Windsor (CA); Pragathi Darapaneni, Auburn Hills, MI (US); Cory Doble, Ortonville, MI (US)

(21) Appl. No.: 17/975,107

(22) Filed: Oct. 27, 2022

Related U.S. Application Data
(60) Provisional application No. 63/274,165, filed on Nov. 1, 2021.

(51) Int. Cl. B01D 53/04; B01J 20/20; B01J 20/26; B01J 20/24; B01J 20/28

(52) U.S. Cl. CPC B01D 53/0415; B01J 20/205; B01J 20/261; B01J 20/262; B01J 20/24; B01J 20/2805; B01J 20/2803; B01J 20/28045; B01D 2253/102; B01D 2253/3425; B01D 2253/25; B01D 2253/202; B01D 2257/702; B01D 2259/4516; B01D 2259/4566; F02M 25/0854

(57) ABSTRACT

A graphene based adsorbent material incorporated into a scrubber forming a portion of a canister or connected to a vent port of the canister in the evaporative emissions management system. The adsorbent material is specifically adsorptive of vaporized hydrocarbons for preventing bleed emissions while also providing low flow restrictions. The graphene adsorbent being provided as an activated graphene derivative and a polymer extruded in a honeycomb design pattern to provide a plurality of passageways for the flow of the vapors. The scrubber connected to the EVAP canister vent port and incorporating a scrubber element exhibiting a honeycomb extruded structure having any combination of activated graphene-derivatives, lignocellulose, charcoal, ceramic, binder and flux material.

### CROSS REFERENCE TO RELATED APPLICATIONS

The present application claims the priority of U.S. Ser. No. 63/274,165 filed Nov. 1, 2021.

### FIELD OF THE INVENTION

The present invention relates generally to adsorbent materials incorporated into an EVAP emissions management system. More particularly, the present invention discloses a graphene based adsorbent scrubber material utilized in combination with an EVAP canister for reducing bleed emissions, this resulting from lack of absorptive capacity of the canister, and which provides the features of higher surface area, along with better adsorption/desorption capabilities.

### BACKGROUND OF THE INVENTION

Automotive Evaporative Emission Control Technology prevents volatile organic compounds (VOC's), such as vaporized hydrocarbons, from escaping into the atmosphere and meeting the EPA/CARB standard under LEV II/LEV III emission standards. The “Evap Canister”, as described above, plays a critical role in the modern Evaporative Emission Control Technology by temporarily adsorbing the vaporized hydrocarbons and letting out only clean air.

Evaporative emissions have no color thereby posing risk of escaping unnoticed. If allowed to escape these vaporized hydrocarbons will react with air in presence of sunlight and generate smog that is harmful to human population and the eco-system at large.

The major sources for evaporative emissions can be traced to refueling and diurnal related emissions. During refueling, when new fuel is added to the automobile gasoline tank from the dispenser nozzle, vaporized hydrocarbons that are displaced from the gasoline tank are vented into the canister. Diurnal emissions occur due to fuel vapors generated as a result of temperature fluctuations during the day and night.

The canister contains an adsorbent material such as a high surface area (activated) carbon. Gasoline vapors primarily composed of hydrocarbon molecules such as butanes and pentanes are attracted to the non-polar surface of the activated carbon and, as a result, are temporarily adsorbed (defined as physisorption or physical adsorption by which the electronic structure of the atom or molecule is barely perturbed upon adsorption), thereby letting out only clean air through the vent port into the atmosphere.

An engine control system, dedicated towards minimizing emissions, facilitates canister purging. During engine combustion air intake, the vacuum created draws air in through the vent port into the canister, flowing through the adsorbent carbon bed resulting in desorption of vaporized hydrocarbons through the purge port into the engine intake.

Often, minute levels of vaporized hydrocarbons remain adsorbed onto the sorbent material during purging. As a result, the air flowing out through the vent port carries with it the remainder hydrocarbons causing “bleed emissions”. Bleed emissions are particularly observed when the fuel tank is heated up causing air to escape into the atmosphere through the vent port.

The bleed emissions are adsorbed by a scrubber containing carbon material that is connected to the canister vent opening. The carbon material may be, for example, activated carbon fiber material or carbon monolith. The scrubber may be made of any suitable material, for example molded thermoplastic polymers such as nylon or polycarbonate. Air leaving the canister may flow through the scrubber. Current commercial scrubbers are extruded into a honeycomb design pattern with activated carbon being the adsorbent material. They are rigid, fragile, and come in very specific dimensions, requiring additional protection against vehicle vibration and shock.

As is also known, the major components of a typical EVAP system include a fuel tank which stores the gasoline and its vapors. The operation of filling pumps is such that they will stop once the nozzle detects an achieved fill level within the tank, this in order to retain a minimal expansion space at the top so that the fuel stored therein so that the fuel can expand without overflowing or forcing the EVAP system to leak.

The EVAP canister is connected to the fuel tank by the tank vent line and, according to conventional designs, typically contains one to two pounds of an activated charcoal that acts like a sponge by absorbing and storing fuel vapors, until the purge valve opens and allows the vacuum of the engine intake to siphon the fuel vapors from the charcoal into the engine intake manifold (desorption) for combustion. The vent control valve allows the flow of the fuel vapors from the fuel tank into the EVAP canister. The purge valve/sensor allows the engine intake vacuum to siphon the fuel vapors from the EVAP canister into the engine intake manifold (desorption process). Vent hoses provide the means by which the fuel vapors flow to different components of the EVAP system. The fuel tank pressure sensor monitors the pressure for leaks and excess pressure built up. Finally, the fuel level sensor monitors the level of fuel in the tank.

Limitations exist to the long-term performance of the activated carbon adsorbent material utilized in conventional EVAP canisters. If the desorption process is not complete it leads to minute residue hydrocarbons on the adsorbent material and, over time, will reduce the adsorption capacity. As a result, during refuelling or during diurnal losses, air flow from fuel tank to the canister and out into the atmosphere through the vent port may contain trace amounts of harmful gasoline components that are now not adsorbed owing to reduced adsorption capacity of the adsorbent material. Although traditionally activated carbon in the form of extruded pellets have been the predominant choice for canister fill, such persistent “bleed” issues remain a problem.

An example of an existing evaporative emission control system with new adsorbents is disclosed in U.S. Pat. No. 7,467,620 to Reddy and which teaches an adsorbent such as an activated carbon having a nearly linear isotherm provided therein.

Other existing approaches drawn from the prior art include U.S. Pat. Nos. 6,896,852 and 7,118,716, both to Meiller et al., which teach a hydrocarbon emissions scrubber for use in an evaporative emissions control system in which a scrubber element incorporates an elongated body defining a plurality of passageways incorporating a sorbent material incorporated into the scrubber as including an activated carbon powder which is adsorptive of hydrocarbons.

U.S. Pat. No. 7,409,946, to King, teaches a fuel vapor recover canister which includes a hydrocarbon filter bed containing carbon granules. A purge vacuum is applied to the canister to draw fuel vapor carrying reclaimed hydrocarbon material from the canister into an intake manifold coupled to an engine so that the reclaimed hydrocarbon material can be burned in the engine.

U.S. Pat. No. 8,372,477, to Buelow et al., teaches a polymeric trap with an adsorbent including any of a zeolitic, activated carbon, silica gel, metal organic framework compound and combinations thereof for adhering particulate material.

US 2020/0147586, to Ruettinger et al., teaches an evaporative emission device and adsorbent of a particulate carbon and a binder further including any of acrylic/styrene, copolymer latex, styrene-butadiene copolymer latex, polyurethane, and mixtures thereof.

U.S. Pat. No. 6,171,556, to Burk, teaches adsorbent compositions including beta zeolites. An oxidant such air is added to the exhaust gas stream at a point upstream of the second catalyst zone.

U.S. Pat. No. 7,021,296, to Reddy, teaches an evaporative emission control system including a scrubber containing activated carbon granules or fibers utilized as an adsorbent, such further including pleated sheets, chopped fibers, fluffy webs, etc., and such as which are selected to adsorb butane and/or pentane isomer vapors in low concentrations in air passing through the scrubber and to desorb the adsorbed butane and/or pentane isomers without being heated.

U.S. Pat. No. 7,753,034, to Hoke et al., teaches another version of hydrocarbon absorption in which the adsorbent is coated as a wash-coat slurry on a support substrate including any of a ceramic, metallic, and polymeric foam, metallic foils, metallic screens, metallic meshes, metallic woven wires and polymeric fibers.

US 2020/0018265, to Chen et al., teaches another version of an EVAP emission control system teaching a variety of hydrocarbon adsorption compositions associated with a bleed emission scrubber, these including any of foams, monolithic materials, non-woven, woven, sheets, papers, twisted spirals, ribbons, extruded forms, and other structured pleated and corrugated forms. Additional adsorbent options include any of activated carbon, carbon charcoal, zeolites, clays, porous polymers, porous alumina, porous silica, molecular sieves kaolin, titania, ceria, and combinations thereof. The activated carbon options further include materials selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, synthetic polymer, natural polymer, lignocellulosic material, and combinations thereof.

Finally, US 2002/0073847, to Sheline et al., teaches a monolith for use in an evaporative emissions hydrocarbon scrubber constructed of a sorbent having a cellular carbon composition having specified wall thicknesses and including an activated carbon and binder. The monolith is concentrically disposed with a shell and has at least one cell group disposed around at least two individual cells, such that the cell group includes at least three thick walls. The individual cells include at least one thin wall. A method for using the evaporative emissions hydrocarbon scrubber is also disclosed.

### SUMMARY OF THE INVENTION

The present invention seeks to address the shortcomings of traditional carbon based adsorbent materials and discloses a graphene based adsorbent material incorporated into a scrubber forming a portion of a canister or connected to a vent port of the canister in the evaporative emissions management system. The new adsorbent material is further specifically adsorptive of vaporized hydrocarbons for preventing bleed emissions while also providing low flow restrictions.

Additional features include the graphene adsorbent being provided as an activated graphene derivative and a polymer extruded in a honeycomb design pattern to provide a plurality of passageways for the flow of the vapors. Additional variants include the scrubber connected to the EVAP canister vent port incorporating a scrubber element exhibiting a honeycomb extruded structure having any combination of activated graphene-derivatives, lignocellulose, charcoal, ceramic, binder and flux material. The group of Graphene-derivatives are not limited to any of monolayer Graphene, few layered Graphene, Graphene oxide, reduced Graphene oxide, and functionalized Graphene. The polymer may further be selected from a group including any of polypropylene, nylon-12, nylon-6, 12, polyethylene, terephthalate, polybutylene, polyphthalamide, polyoxymethylene, polycarbonate, polyvinylchloride, polyester, and polyurethane.

In another embodiment, a novel design of a scrubber may include graphene derivative polymer in the form of a foam with enhanced surface area to prevent bleed emissions of vaporized hydrocarbons. Other variants include the scrubber element incorporating any type of foam or felt material and again including any combination of graphene-derivatives, lignocellulose, and charcoal. The polymer maybe selected from a group including any of polypropylene, nylon-12, nylon-6, 12, nylon-6, 6, polyethylene, terephthalate, polybutylene, polyphthalamide, polyoxymethylene, polycarbonate, polyvinylchloride, polyester, and polyurethane.

### BRIEF DESCRIPTION OF THE DRAWINGS

Reference will now be had to the attached illustrations, when read in combination with the following detailed description, wherein like reference numerals refer to like parts throughout the several views, and in which:

FIG. 1 is a perspective illustration of an evaporative emission control system including a graphene based adsorbent material incorporated into a scrubber forming a portion of a canister or connected to a vent port of the canister;

FIG. 2 is a related schematic view of an EVAP system as depicted in incorporating a vapor canister;

FIG. 3 is a further cutaway illustration of an EVAP canister, such as which can be filled with activated carbon material, and which illustrates the various chambers associated with the adsorption/desorption process including the provision of the new scrubber function for preventing bleed emissions through the vent to the atmosphere, and as distinguished from the vent line connecting to the vehicle fuel tank;

FIG. 4 is an illustration of a scrubber element connected to a canister via the canister vent port and having a honeycomb extruded structure including any combination of activated graphene-derivatives, lignocellulose, charcoal, ceramic, binder, and flux material;

FIG. 5 is a further illustration of a scrubber element similar to FIG. 4 and having a foam and/or felt structure which can include any combination of graphene-derivatives, lignocellulose, and charcoal;

FIG. 6 is a further illustration of a scrubber element similar to FIG. 3 and having a foam structure placed anywhere inside the canister and which can include any combination of graphene-derivatives, lignocellulose, and charcoal;

FIG. 7 is a further illustration of a scrubber element similar to FIG. 6 and having a felt structure placed anywhere inside the canister and which can include any combination of graphene-derivatives, lignocellulose, and charcoal; and

FIG. 8 is a yet further illustration of a scrubber element which is a hybrid of FIGS. 6 and 7 and which includes both of foam and felt structures placed inside the canister, and which can include any combination of graphene-derivatives, lignocellulose, and charcoal.

### DETAILED DESCRIPTION OF THE PREFERRED EMBODIMENTS

With reference to the attached illustrations, the present invention seeks to address the shortcomings of traditional carbon based adsorbent materials and discloses instead a graphene based adsorbent material utilized in an EVAP canister forming a portion of an evaporative emissions management system and in particular for use as a scrubber material for reducing or entirely removing bleed emissions in order to discharge only clean air through the EVAP canister vent into the surrounding atmosphere.

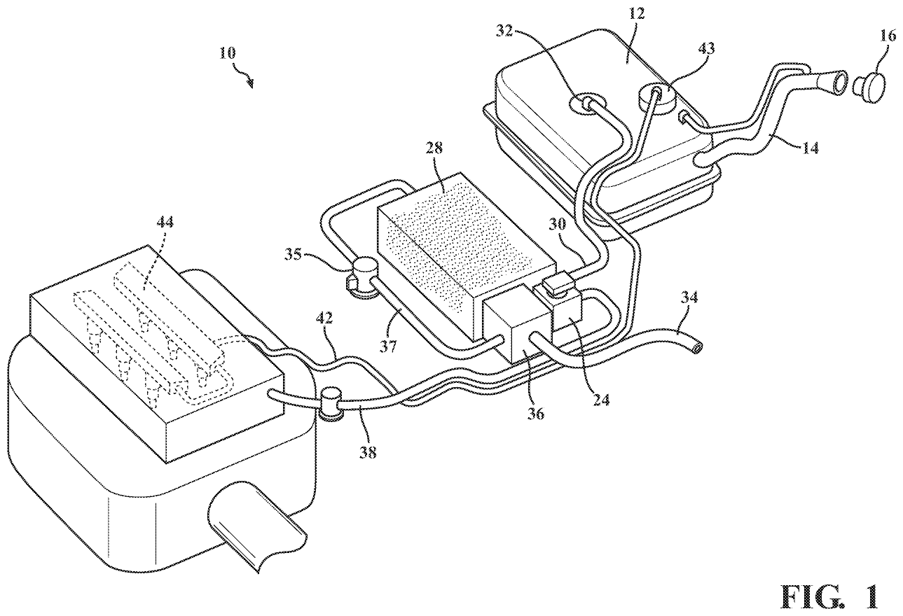

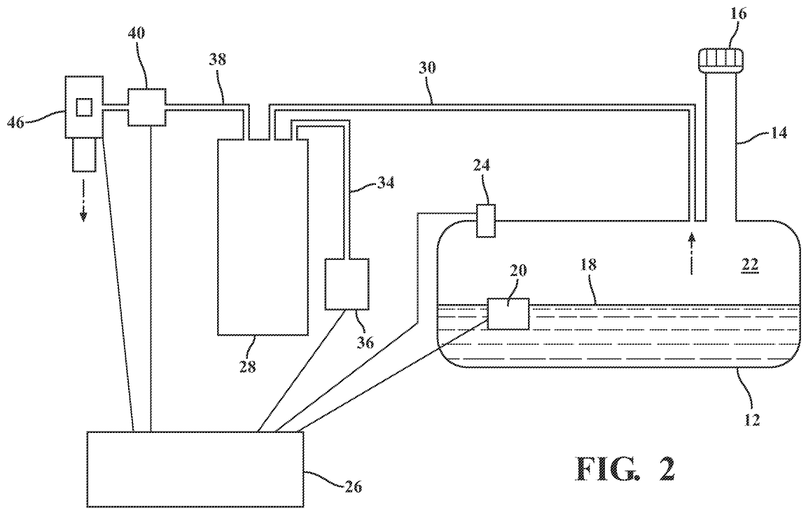

FIG. 1 is a perspective view and FIG. 2 a schematic of a construction of an evaporative emission control system, generally referenced 10 in FIG. 1, and including a fuel tank 12 with an extending fill neck 14 and a sealed fuel cap 16. The gas tank is further shown in cutaway in FIG. 2 and depicts liquid gasoline defining a fill level 18 which is read by a fuel level sensor 20. Above the fill level, an unoccupied upper expansion space or volume of the tank is occupied by fuel vapors 22. A fuel tank pressure sensor 24 is also located in the tank 12 and, in combination with the fuel level sensor 20, supplies fill level and tank pressure readings to a suitable Powertrain Control Module (PCM) 26.

An EVAP vapor canister 28 is provided and is communicated by a vapor inlet line 30 extending from the fuel tank 12, this communicating with a vent control valve (see at 32 in FIG. 1) for allowing the flow of fuel vapors from the fuel tank into the EVAP canister 28. An EVAP line 34 extending from the canister 28 includes a normally open EVAP solenoid (canister) vent valve 36. An evaporative two way valve 35 is incorporated into a line 37 extending between the EVAP canister 28 and the EVAP canister vent valve 36.

A further line 38 extends from the canister 28 to a purge flow sensor 40 which is connected to an air induction system and allows the engine intake vacuum to siphon precise amounts of fuel vapors for delivery via a line 42, extending from a fuel pump 43 incorporated into the fuel 12, into an engine intake manifold (see further at 44 in FIG. 1). The PCM module 26 also receives inputs from each of the EVAP vent solenoid 36, purge flow sensor 40 and an EVAP purge solenoid 46 located downstream from the purge flow sensor 40 and through which vapors are permitted to flow to the throttle body.

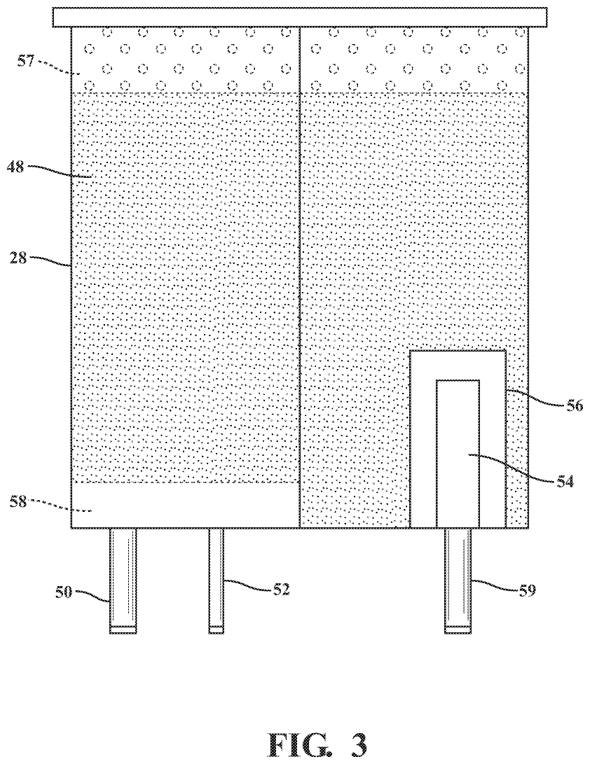

FIG. 3 is a further cutaway illustration of an EVAP canister, such as previously depicted at 28 in FIGS. 1-2, and which can be filled with an activated carbon material 48. The canister further illustrates the various chambers associated with the adsorption process (see arrow 50 representing load port) for drawing the hydrocarbon vapors from the fuel tank through the vent line. Also shown is purge port 52 for desorbing the retained hydrocarbons to the engine intake manifold during combustion.

Also depicted is a scrubber function (see scrubber element 54) which can be incorporated into a separate housing 56 as shown in FIG. 3 or, alternatively, can be incorporated directly within the canister 28. The scrubber 54 in this variant also includes an activated carbon material for preventing evaporative bleed emission through a separate vent port 59 into the atmosphere.

Either of a foam 57 or a felt 58 structure can be placed anywhere within the canister, such as including providing opposite sandwiching layers for the activated carbon 48. The activated carbon material can also include provision of activated graphene-derivative powder and a polymer extruded in a honeycomb design pattern to provide a plurality of passageways for the flow of the fuel vapor. The polymer may further be selected from a group including any of polypropylene, nylon-12, nylon-6, 12, polyethylene, terephthalate, polybutylene, polyphthalamide, polyoxymethylene, polycarbonate, polyvinylchloride, polyester, and polyurethane.

In another embodiment, a novel design of a scrubber may include graphene-derivatives and a polymer in form of a foam or felt with enhanced surface area to prevent bleed emissions of vaporized hydrocarbons. The polymer maybe selected from a group including any of polypropylene, nylon-12, nylon-6, 12, nylon-6, 6, polyethylene, terephthalate, polybutylene, polyphthalamide, polyoxymethylene, polycarbonate, polyvinylchloride, polyester, and polyurethane.

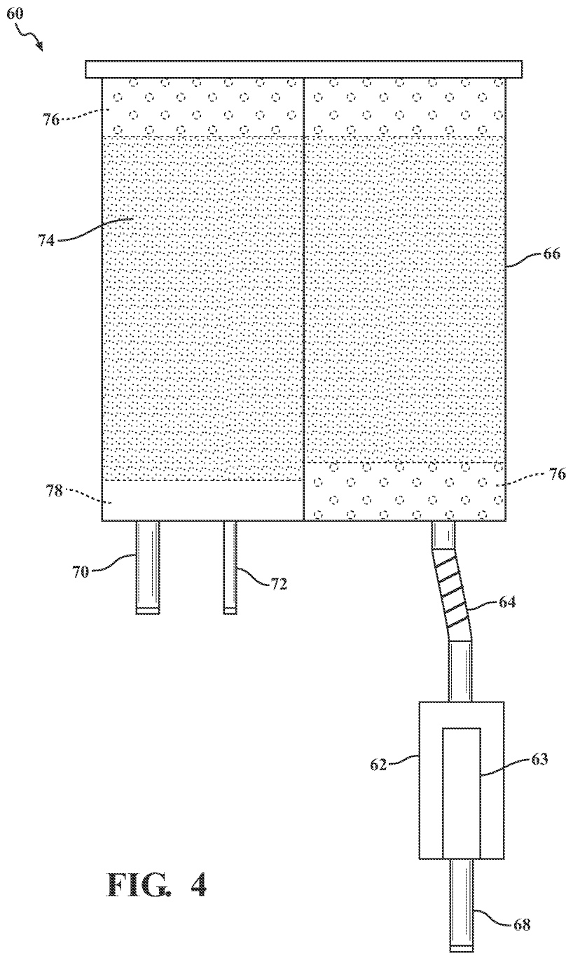

FIG. 4, as generally depicted at 60, provides an illustration of a combination EVP canister and scrubber, and in which the scrubber, shown at 62, is connected, via a vent port 64, to an EVAP canister 66, the canister being similar in construction to that previously described. The scrubber 62 includes an outer housing and incorporates an interior element (see at 63), such exhibiting a honeycomb extruded structure including any combination of activated graphene-derivatives, lignocellulose, charcoal, ceramic, binder, and flux material. Also depicted at 68 is a tubular housing end of the scrubber. Additional features include both load 70 and purge ports 72 (these again repetitively shown at 30 and 34 in FIG. 2). As previously described in FIG. 3, the reconfigured canister 66 can again include each of an activated carbon 74 and respective form 76 and/or felt 78 layers, such as at opposite sandwiching ends for packing in the carbon material.

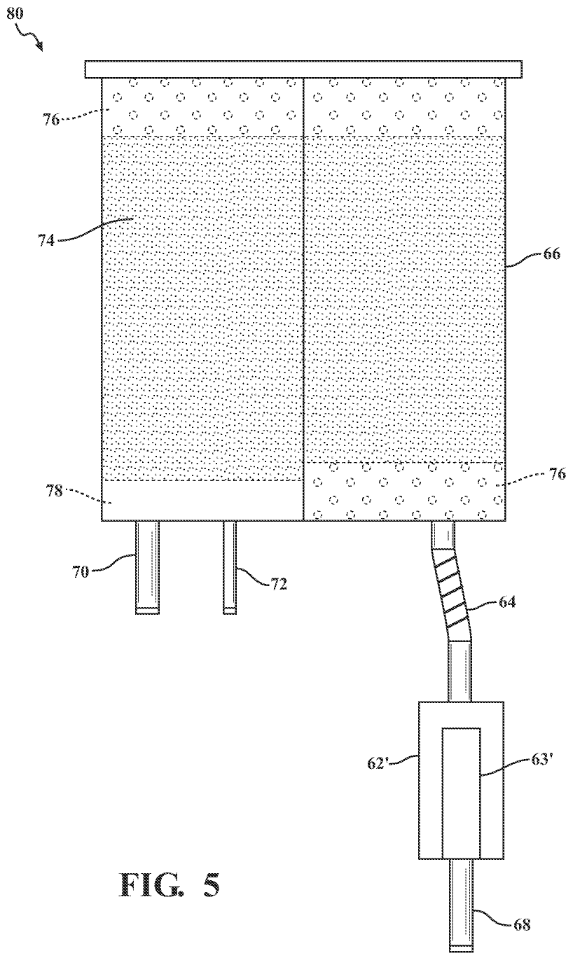

FIG. 5 is a further illustration of a scrubber element, see generally at 80, which is similar in construction to FIG. 4 such that identical elements are repetitively numbered. A variation of the scrubber, at 62′, incorporates an interior element 63′ having any of a foam and/or felt structure which can include any combination of graphene-derivatives, lignocellulose, and charcoal.

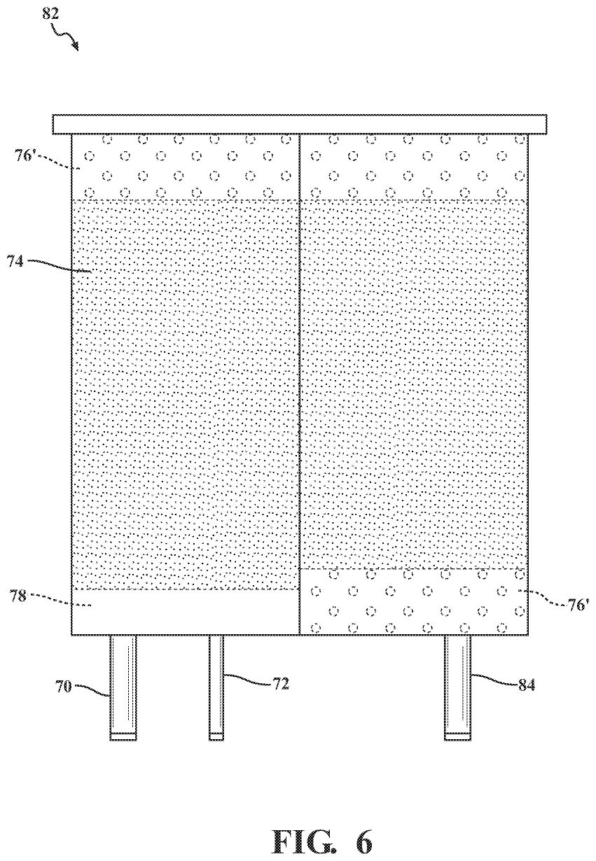

Proceeding to FIG. 6, a further illustration of a scrubber element is shown at 82, similar to FIG. 3, and having a foam structure placed anywhere inside the canister (see as referenced at each of 76′) and which can include any combination of graphene-derivatives, lignocellulose, and charcoal. Referencing again FIG. 5, this can again include a reconfigured scrubber element foam layer (see at 76′), along with previously described activated carbon 74 and felt 78 layers. Other features including each of the load 70 and purge 72 ports are repeated, as is a revised vent port 84.

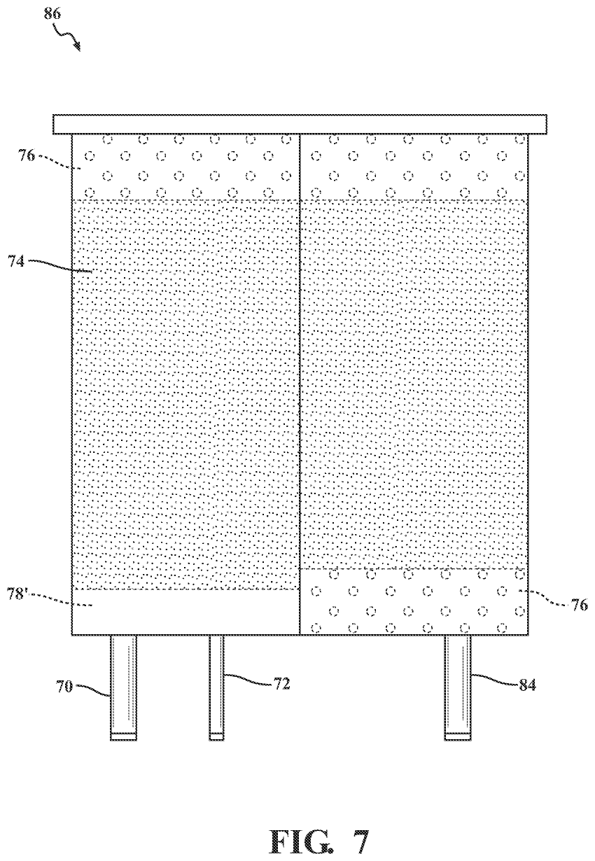

FIG. 7 is a further illustration, at 86 of a scrubber element similar to FIG. 6 again incorporated into a canister and having a felt structure (see as revised at 78′) which can be placed anywhere inside the canister and which can include any combination of graphene-derivatives, lignocellulose, and charcoal. The remaining features are repetitively numbered as shown in each of FIGS. 4-6.

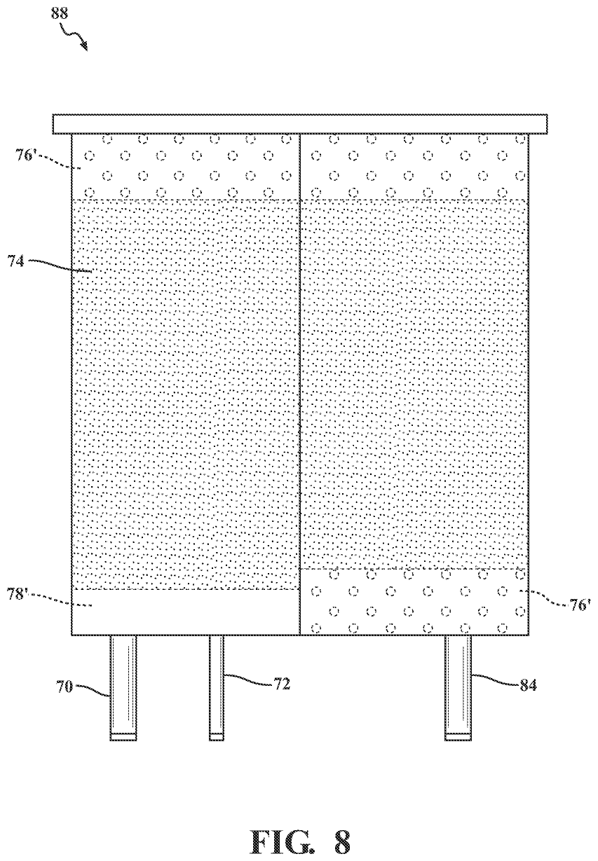

Finally, FIG. 8 is a yet further illustration of a scrubber element, at 88, which is a hybrid of FIGS. 6 and 7 and which includes both of foam 76′ and felt 78′ structures placed at various upper and lower locations inside the canister, and which can again include any combination of graphene-derivatives, lignocellulose, and charcoal. Other repetitive features are repeated from each of FIGS. 4-7

The new adsorbent material may again include any Graphene-derivatives incorporated in a polymer in the form of any of a foam material that is used to maintain the canister volume and enable proper adsorption of fuel vapors in the canister. The group of Graphene-derivatives are not limited to any of monolayer Graphene, few layered Graphene, Graphene oxide, reduced Graphene oxide, or functionalized Graphene. As previously stated, the Graphene or Graphene derivative sorbent material is provided as any of a powder extruded, stamped or molded pellets and activated using either of a chemical or thermal technique.

The loading concentration of Graphene-derivatives in the scrubber element may vary, without limitation, from 0.1-60 percent by weight. The scrubber element can also contain a polymer, including without limitation a thermoplastic polymer, and can be chosen from, but not restricted to, any of polyurethane, polyester, polypropylene, nylon 6, nylon 6,6, nylon-12, nylon-6,12, polyethylene, terephthalate, polybutylene, polyphthalamide, polyoxymethylene, polycarbonate, and polyvinylchloride.

In another embodiment, the adsorbent scrubber material may be a combination of Graphene-derivatives and lignocellulosic material or charcoal incorporated into the volume compensator foam. The Graphene-derivatives incorporated in a polymer in the form of a felt that is used to pack down the adsorbent material in the canister. The group of Graphene-derivatives that include but not limited to monolayer Graphene, few layered Graphene, Graphene oxide, reduced Graphene oxide, or functionalized Graphene. The loading concentration of Graphene-derivatives may again vary, without limitation, from 0.1-60 percent by weight.

The polymer may again include a thermoplastic polymer and may be chosen from, but not restricted to polyurethane, polyester, polypropylene, nylon 6, nylon 6,6, nylon-12, nylon-6,12, polyethylene, terephthalate, polybutylene, polyphthalamide, polyoxymethylene, polycarbonate, and polyvinylchloride. As previously described, the new adsorbent material may include a combination of Graphene-derivatives and lignocellulosic material or charcoal incorporated into the foam or felt.

Other variants include the adsorbent material provided as a powder of activated Graphene-derivatives and a polymer extruded in the honeycomb design pattern to provide plurality of passageways for the flow of fuel vapor. The polymer may again be selected from a group including, without limitation, of polypropylene, nylon-12, nylon-612, polyethylene, terephthalate, polybutylene, polyphthalamide, polyoxymethylene, polycarbonate, polyvinylchloride, polyester, and polyurethane. The powder can include a combination of activated Graphene-derivatives and lignocellulosic material or charcoal.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A combination canister and scrubber incorporated into an evaporative emissions control system for an automobile for reducing evaporative emissions, said combination canister and scrubber comprising a housing containing a Graphene-derivative sorbent material which is adsorptive of vaporized hydrocarbons for preventing bleed emissions while also providing low flow restrictions.

2. The invention of claim 1, said housing further comprising a main housing incorporating said canister and a separate housing incorporating said scrubber.

3. The invention of claim 1, said scrubber housing either being incorporated within said canister housing or connected to said main housing via a vent port.

4. The invention of claim 1, further comprising said Graphene-derivative material being selected from a group not limited to any of monolayer Graphene, few layered Graphene, Graphene oxide, reduced Graphene oxide and functionalized Graphene, said Graphene or Graphene derivative based sorbent material further being activated using either of a chemical or thermal technique.

5. The invention of claim 1, said Graphene-derivative sorbent material further comprising any of a foam, felt or powder.

6. The invention of claim 5, further comprising an activated carbon sandwiched between one or more layers of said foam, felt or powder.

7. The invention of claim 1, further comprising said Graphene-derivative material being mixed with a polymer.

8. The invention of claim 1, further comprising said Graphene-derivative sorbent material extruded in a honeycomb design pattern to provide plurality of passageways for a flow of vapor through said scrubber.

9. The invention of claim 5, said graphene foam further comprising said Graphene-derivative material being selected from a group not limited to any of monolayer Graphene, few layered Graphene, Graphene oxide, reduced Graphene oxide and functionalized Graphene.

10. The invention of claim 1, further comprising a loading concentration of said Graphene-derivatives being provided in a range of 0.1-60 percent by weight.

11. The invention of claim 7, said polymer further comprising a thermoplastic polymer selected from a group including any one or more of a polyurethane, polyester, polypropylene, nylon 6, nylon 6,6, nylon-12, nylon-6,12, polyethylene, terephthalate, polybutylene, polyphthalamide, polyoxymethylene, polycarbonate, and polyvinylchloride.

12. The invention of claim 5, further comprising said Graphene-derivative sorbent material being combined with any of a lingocellulosic material or a charcoal incorporated into said felt.

13. A canister and scrubber incorporated into an evaporative emissions control system for an automobile for reducing evaporative emissions, comprising:
the canister including a main housing and the scrubber including a separate housing, each containing an activated carbon material;
at least the main canister housing further including one or more layers of any of a foam, felt or powder between which is sandwiched said activated carbon material; and
said layers of foam, felt or powder further including a Graphene-derivative sorbent material which is adsorptive of vaporized hydrocarbons for preventing bleed emissions while also providing low flow restrictions.

14. The invention of claim 13, further comprising said Graphene-derivative material being selected from a group not limited to any of monolayer Graphene, few layered Graphene, Graphene oxide, reduced Graphene oxide and functionalized Graphene.

15. The invention of claim 13, further comprising said Graphene-derivative material being mixed with a polymer.

16. The invention of claim 13, further comprising said Graphene-derivative sorbent material extruded in a honeycomb design pattern to provide plurality of passageways for a flow of vapor through said scrubber.

17. The invention of claim 13, further comprising a loading concentration of said Graphene-derivative material being provided in a range of 0.1-60 percent by weight.

18. The invention of claim 15, said polymer further comprising a thermoplastic polymer selected from a group including any one or more of a polyurethane, polyester, polypropylene, nylon 6, nylon 6,6, nylon-12, nylon-6,12, polyethylene, terephthalate, polybutylene, polyphthalamide, polyoxymethylene, polycarbonate, and polyvinylchloride.

19. The invention of claim 13, further comprising said Graphene-derivative sorbent material being combined with any of a lignocellulosic material or a charcoal incorporated into said layers of felt.

20. A canister and scrubber incorporated into an evaporative emissions control system for an automobile for reducing evaporative emissions, comprising:
a main canister housing and a separate scrubber housing, each containing an activated carbon material;
at least the main canister housing further including one or more layers of any of a foam, felt or powder between which is sandwiched said activated carbon material, said layers of foam, felt or powder further including a Graphene-derivative sorbent material which is adsorptive of vaporized hydrocarbons for preventing bleed emissions while also providing low flow restrictions;
said Graphene-derivative material being selected from a group not limited to any of monolayer Graphene, few layered Graphene, Graphene oxide, reduced Graphene oxide and functionalized Graphene; and
said Graphene-derivative material being mixed with a polymer selected from a group including any one or more of a polyurethane, polyester, polypropylene, nylon 6, nylon 6,6, nylon-12, nylon-6,12, polyethylene, terephthalate, polybutylene, polyphthalamide, polyoxymethylene, polycarbonate, and polyvinylchloride.
